(19) United States
(12) Patent Application Publication
(10) Pub. No.: US 2007/0212669 A1
(43) Pub. Date: Sep. 13, 2007

(54) System and method for generating and providing access to a deep map

(75) Inventors: Michael R. Counts, Brooklyn, NY (US); Christopher J. Allen, Brooklyn, NY (US); Jesse M. Shapins, Brooklyn, NY (US); Brian J. House, Brooklyn, NY (US)

Correspondence Address: PILLSBURY WINTHROP SHAW PITTMAN, LLP, P.O. BOX 10500, MCLEAN, VA, 22102, US

(73) Assignee: Counts Media, Inc., New York, NY (US)

(21) Appl. No.: 11/373,219

(22) Filed: Mar. 13, 2006

(51) Int. Cl. G09B 25/06

(52) U.S. Cl. 434/130

(57) ABSTRACT

A system and method for generating and providing access to a deep map. The system and method may enable a host to administer a deep map that may be generated interactively by one or more users that may be unaffiliated with the host. The system and method may enhance user access to the deep map administered by the host. The system and method may enable incorporation of perspective, as well as simple position or placement, into the deep map. For instance, a directional orientation of a user may be incorporated into the deep map.

### FIELD OF THE INVENTION

The invention relates generally to a system and method for generating and providing access to a deep map.

### BACKGROUND OF THE INVENTION

A deep map, among other things, provides contemporary, historical, political, artistic, poetic, philosophical, thoughtful, and/or other information or commentary related to a place by blending information to create a map that “represents” the place in a manner that may be more comprehensive than simple topography. Typically, deep mapping is a process of associating one or more entities within a geographical area with information that corresponds to the entities to create points of interest within the deep map. Optionally, the deep map may be stored or recorded in any tangible media, such as, for example, optical storage media, magnetic storage media, digital storage media, analog storage media, printed media, or other media. An entity may include, as non-limiting examples, a specific location, a structure, a building, a natural landmark, a manmade landmark, an article of commerce, a person, a picturesque view, or other entities. The information associated with an entity may include, as non-limiting examples, historical events that are related to an entity; interesting observations about an entity; the physical appearance, smell, sound, and/or feel of an entity now or over time; a geographic location of an entity; or other information.

In the past, deep maps have generally been generated by researching information associated with entities, determining which information to include in the deep map, associating the information with the appropriate entities to create points of interest, and aggregating all of the points of interest so that they may be conveyed to a user. Such attempts to create a deep map may be limited by the massive amount of information that must be procured, filtered and/or ranked, and associated with entities.

An amount of information included in a deep map may pose challenges to providing access to a deep map using known methods. For instance, users may be required to purchase specialized equipment such as, for example, printed materials (books, maps, etc.), software, hardware, or other equipment. The amount of information included in a deep map may also create difficulties for users that desire to access a specific point of interest. Other drawbacks related to conventional deep maps also exist.

### SUMMARY

The invention relates generally to a system and method for generating and providing access to a deep map. The system and method may enable a host to administer a deep map that may be generated interactively by one or more users that may be unaffiliated with the host. Generating the deep map interactively may enable an amount of effort required for generation of the deep map to be distributed among a plurality of parties, may incorporate a plurality of objective view points as to points of interest that should be included in the deep map, or provide other advantages. The system and method may enhance user access to the deep map administered by the host. For example, access may be enhanced by enabling a user to access the deep map without owning or purchasing specialized equipment, a user may access the deep map on location, a user may access a desired point of interest within the deep map in an intuitive manner, a user may create groups of correlated points of interest within the deep map, or access may be otherwise enhanced. The system and method may enable incorporation of perspective, as well as simple position or placement, into the deep map. For instance, a directional orientation of a user may be incorporated into the deep map. This may enable a plurality of representations of a single position, or point, within the deep map that may depend on the direction that a user may be facing.

One aspect of the invention may relate to a method of generating and providing access to a deep map. The deep map may be administered by a host. The method may include transferring a marker with an identifier from the host to a first user, enabling the first user to use the marker to incorporate an entity into the deep map as a point of interest, and enabling a second user to access the point of interest created by the first user.

In some embodiments of the invention, a marker may be provided by the host directly to a user. Or, the marker may be provided by the host to an intermediary, or marker distributor, which may, in turn, distribute the marker to the user. The marker may be provided gratis, or, the marker may be sold to the marker distributor and/or the user.

According to various embodiments of the invention, the identifier may identify the marker. The identifier may include alphanumeric symbols, other symbols, an optical code, a magnetic code, an RFID signal or other identifiers. The identifier may be unique to the marker, or in some instances a plurality of markers may include the same identifier. This may enable a plurality of points of interest associated with the plurality of markers that include the same identifier to be easily accessed as a group within the deep map. In other instances, a plurality of markers may be correlated without sharing a common identifier. For example, the plurality of markers may include identifiers that only share a common portion (e.g. a common identifier prefix), the plurality of markers may include identifiers that are consecutive, the plurality of markers may be correlated within the deep map in a manner not related to the identifiers, or otherwise correlated without sharing a common identifier. The plurality of points of interest may be correlated to designate a common user, to designate a designed tour of a geographic area, according to a game, to designate an association with a particular entity or set of entities, by geographic area, according to a particular area of interest, or otherwise correlated.

In some embodiments, a user may use a marker to incorporate an entity into the deep map as a point of interest. The user may not be affiliated with the host. The user may incorporate the entity by selecting the entity for incorporation into the deep map, associating the marker with the entity, accessing the deep map by providing the identifier included in the marker, and providing point of interest information to the deep map.

According to some embodiments of the invention, the user may associate the marker with the entity by placing the marker such that other users that see the associated marker will affiliate the entity with the marker and vice versa. For example, the marker may be affixed to the entity, may be placed to draw attention to the entity, or otherwise associated with the entity.

According to various embodiments of the invention, the user may access the deep map by providing the identifier included in the marker. The identifier may be provided to the host. The user may provide the identifier to the host from the site of the entity to access the deep map on location. In some instances, the user may provide the identifier via electronic communication. For example, the user may provide the identifier over a network connection, such as a LAN connection (e.g. via a web client over an internet connection) or other network connection, a wireless connection (e.g. via text messaging using a wireless network protocol), or other electronic communication. In some instances, the user may provide the identifier via a short messaging service (SMS), a multimedia message service (MMS), an internet message service (IMS), an internet connection, and/or wireless application protocol (WAP).

In some embodiments of the invention, after accessing the deep map by providing the identifier, the user may provide point of interest information to the deep map. The user may provide point of interest information to the deep map by providing the point of interest information to the host. Point of interest information may be composed of information selected entirely by the user, required information related to the entity, required information related to the user, or a combination of some or all of the above mentioned types of information. For example, the point of interest information may include the geographic location of the entity, and other information related to the entity that the user would like others to be able to access. For instance, point of interest information may include information associated with the entity typically included in deep maps; artistic material inspired by, reminiscent of, or otherwise related to the entity; a user's opinion about the entity; a command, cue, or request for a future user accessing the point of interest to perform an action; a question; a challenge; a way of interpreting an aspect of the entity; or other information. Some or all of the information may be entered automatically, such as, for example, GPS coordinates from which the user is accessing the deep map via a wireless connection, or other information. Point of interest information may include various types of media, such as, video, audio, still images, text, or other types of media. The identifier and the point of interest information may enable generation of a point of interest in the deep map.

According to various embodiments, a user may access a point of interest in the deep map that may have been previously incorporated into the deep map by another user. The users may not be affiliated with the host. The user may access the point of interest by acquiring an identifier from a marker that has been associated with an entity, accessing the deep map by providing the identifier included in the marker, and receiving point of interest information related to the entity from the deep map.

In some embodiments, the user may access the deep map by providing the identifier included in the marker. The user may provide the identifier to the host that administers the deep map. In some instances, the user may provide the identifier via electronic communication. For example, the user may provide the identifier over a network connection, such as a LAN connection (e.g. via a web client over an internet connection) or other network connection, a wireless connection (e.g. via text messaging using a wireless network protocol), or other electronic communication. In some instances, the user may provide the identifier via a short messaging service (SMS), a multimedia message service (MMS), an internet message service (IMS), an internet connection, and/or wireless application protocol (WAP).

According to various embodiments of the invention, the user may receive point of interest information related to the entity associated with the identifier provided by the user. The point of interest may be provided by the host. In some instances, the user may receive the point of interest information via electronic communication. For example, the user may receive the point of interest information over a network connection, such as a LAN connection (e.g. via a web client over an internet connection) or other network connection, a wireless connection (e.g. via text messaging using a wireless network protocol), or other electronic communication. In some instances, the user may receive the point of interest information via a short messaging service (SMS), a multimedia message service (MMS), an internet message service (IMS), an internet connection, and/or wireless application protocol (WAP).The user may receive the point of interest information via the connection that the user provided the identifier to the deep map, or via another connection.

In some embodiments of the invention, the user, after receiving the point of interest information, may provide comment information related to the point of interest in the deep map. The user may provide the comment information to the host. The comment information may be incorporated into the deep map as information associated with the point of interest. Comment information may include various types of media, such as, audio, video, still images, text, or other types of media. Comment information may be provided with point of interest information to users that access the point of interest in the future. In some embodiments, the host may associate host comment information with the point of interest. Host comment information may include advertising information, sponsor information, information related to the popularity of the point of interest, information related to the subjective merit of the point of interest, or other host comment information.

According to various embodiments, point of interest information, comment information, and/or host comment information may be edited. For example, a user that incorporates an entity into the deep map as a point of interest may subsequently edit originally provided point of interest information. The user may edit comment information included in the point of interest by other users. Similarly, the host may edit any or all of the point of interest information, the comment information, and the host comment information. In some embodiments, point of interest information and/or comment information may not be included in the deep map unless the information has been reviewed and approved by the host. Comment information may be excluded from inclusion into the deep map subject to approval by the user that originally incorporated the entity into the deep map as the point of interest.

Another aspect of the invention may relate to a method of enabling a user and/or the host to access the deep map to select points of interest to be correlated. For example, correlating points of interest may include grouping points of interest, ordering points of interest, linking points of interest, associating points of interest with other points of interest, organizing points of interest, or otherwise correlating points of interest. The method may include, enabling a user and/or the host to access the deep map without specifying a particular point of interest, enabling a user and/or the host to explore points of interest included in the deep map, enabling a user and/or the host to select one or more of the points of interest, correlating selected points of interest, and providing correlated points of interest as a group of points of interest.

In some embodiments of the invention, a user that may not be affiliated with the host may access the deep map as a whole. In such instances, the deep map may be provided to the user by the host according to a deep map organization option. For example, the deep map may be provided to the user in a cartographic form, wherein the user may select geographic locations within the deep map to access points of interest, the deep map may be provided to the user in a gallery form, wherein point of interest information is provided to the user as a gallery of points of interest, or the deep map may be provided to the user according to other deep map organization options.

According to various embodiments of the invention, a user that may not be affiliated with the host and/or the host may explore points of interest included in the deep map. For example, the user and/or the host may explore, or browse, points of interest that have been previously correlated. In other instances, the user and/or the host may explore points of interest that may or may not have been correlated using known search techniques such as, for example, word searches, popularity, or other search techniques.

In some embodiments, a user that may not be affiliated with the host and/or the host may select one or more points of interest included in the deep map. Selected points of interest may be correlated in a manner that may be specified by the user and/or the host. The user may select points of interest for correlation to create a group of points of interest that may then be provided to the user, or other users, together. This may provide one or more advantages to the user and/or the host such as, for example, pre-planning a tour of a geographic area (e.g. a city), creating and/or playing a game, correlating favorite points of interest, providing correlated points of interest to other users, or other advantages.

Another aspect of the invention may relate to a system for generating and providing access to a deep map. The system may include one or more markers, one or more remote terminals, a central processor, and one or more storage components. The system may enable a host to administer the deep map such that the deep map may be generated interactively by one or more users that may not be affiliated with the host. The system may enable a user may incorporate an entity into the deep map as a point of interest by associating a marker with the entity, inputting an identifier included in the marker to the central processor via the remote terminal, and inputting point of interest information to the central processor via the remote terminal. The central processor may correlate the identifier with the point of interest information and transmit the correlated information to the storage components. The central processor and/or one or more of the storage components may be managed, controlled, maintained, or otherwise administered by the host. A user may access a point of interest within the deep map by acquiring the identifier from a marker associated with an entity, and inputting the identifier to the central processor via a remote terminal. The central processor may then retrieve point of interest information that corresponds to the identifier and transmit the point of interest information to the user, who may receive the point of interest information via the remote terminal.

In some embodiments of the invention, the central processor may include one or more modules. The modules may be implemented in hardware, software, firmware, or in a combination of some or all of hardware, software, and firmware. In some instances, the modules may include an interface module, a correlation module, and a retrieval module.

According to various embodiments of the invention, an interface module may provide an interface between a user and the central processor. The interface may include a host interface that may be located at the central processor or remote from the central processor, an interface that may enable a user to access the central processor as a client via a remote terminal, or other interfaces. The interface module may enable the user and/or the host to access the central processor via a graphical user interface (GUI). Accessing the central processor may enable the host to administer the deep map. Accessing the central processor may enable the user to provide an identifier to incorporate a point of interest into the deep map, enable the user to provide an identifier to receive point of interest information, enable the user to provide point of interest information to the deep map, enable the user to receive point of interest information, enable the user to otherwise access the deep map to view, manipulate, order, link, edit, select, organize, or access information associated with the deep map, or enable other functionalities.

In some embodiments, a correlation module may correlate point of interest information with one or more identifiers. The correlation module may correlate point of interest information that is input by a user with an identifier that is input by the user so that the point of interest information may be retrieved by the identifier at a future time. In some instances, the correlation module may correlate a plurality of points of interest. For example, correlating a plurality of points of interest may include organizing a plurality of points of interest according to identifiers and/or point of interest information. For instance, a plurality of points of interest may be correlated to designate a common user, to designate a designed tour of a geographic area, according to a game, to designate an association with a particular entity or set of entities, by geographic area, according to a particular area of interest, or otherwise correlated. A plurality of points of interest may be correlated based on user interaction, based on host interaction, or according to automated instructions.

According to various embodiments of the invention, a retrieval module may retrieve point of interest information from the storage components. The retrieval module may retrieve point of interest information from the storage components based on an identifier that is provided to the central processor by a user as a request for point of interest information to be transmitted to the user, based on other user interaction, based on host interaction, or based on automated instructions.

Another aspect of the invention may relate to organizing a plurality of correlated points of interest within the deep map as a constituent deep map. For example, a constituent deep map may include a plurality of points of interest that may be correlated to designate a common user, to designate a designed tour of a geographic area, according to a game, to designate a particular entity or set of entities, by geographic area, according to a particular area of interest, or otherwise correlated. Organizing a plurality of correlated points of interest as a constituent deep map may enable users accessing points of interest in a constituent deep map to explore and access other related points of interest within the constituent deep map.

According to various embodiments of the invention, a plurality of points of interest may be correlated to provide a designed tour of a geographic area. In such instances, the points of interest may be grouped and ordered so that a user taking the tour may proceed along the designated route. Point of interest information included in the points of interest correlated to provide a tour may include directions to and from the various points of interest to guide the user. Points of interest may be correlated to provide a tour by one or more users, or by the host.

In some embodiments, a plurality of points of interest may be correlated according to a game. In such instances, point of interest information included in the points of interest correlated according to a game may include commands, cues, or requests for users to perform prescribed actions. The prescribed actions may include, as non-limiting examples, searching for designated entities, interacting with certain entities (e.g. saying certain words to a designated individual), traveling to another point of interest included in the deep map, or other actions. Points of interest may be correlated according to a game by one or more users, or by the host. Other embodiments of correlating points of interest exist.

In some embodiments of the invention, a plurality of constituent deep maps that overlap with one another may form a compound deep map. Organizing points of interest into constituent and compound deep maps may enable users accessing points of interest in a constituent deep map to explore and access other related constituent deep maps.

These and other objects, features, and advantages of the invention will be apparent through the detailed description of the preferred embodiments and the drawings attached hereto.

### BRIEF DESCRIPTION OF THE DRAWINGS

FIG. 1 is an exemplary illustration of a method of generating and providing access to a deep map

FIG. 2 is an exemplary illustration of a method of enabling a user to incorporate an entity into a deep map as a point of interest.

FIG. 3 is an exemplary illustration of a method of enabling a user to access a point of interest in a deep map.

FIG. 4 is an exemplary illustration of a method of enabling a user to access a deep map.

FIG. 5 is an exemplary illustration of a system for generating and providing access to a deep map.

FIG. 6 is an exemplary illustration of an organization of a deep map including constituent deep maps and compound deep maps.

FIG. 7 is an exemplary illustration of a marker.

FIG. 8 is an exemplary illustration of a marker.

FIG. 9 illustrates several embodiments of markers.

### DETAILED DESCRIPTION OF THE DRAWINGS

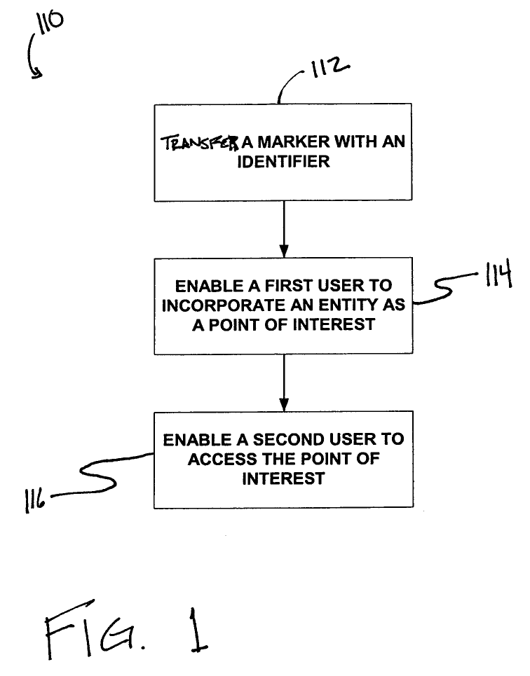

FIG. 1 illustrates and exemplary embodiment of a method 110 of generating and providing access to a deep map that may be administered by a host. The method may include an operation 112 transferring a marker with an identifier from the host to a first users, an operation 114 enabling the first user to incorporate an entity into the deep map as a point of interest, and an operation 116 enabling a second user to access the point of interest created by the first user.

In some embodiments of the invention, at operation 112, a marker may be provided by the host directly to a user. Or, the marker may be provided by the host to an intermediary, or marker distributor, which may, in turn, distribute the marker to the user. The marker may be provided gratis, or, the marker may be sold to the marker distributor and/or the user.

According to various embodiments of the invention, the identifier may identify the marker. The identifier may include alphanumeric symbols, other symbols, an optical code, a magnetic code, an RFID signal, or other identifiers. The identifier may be unique to the marker, or in some instances a plurality of markers may include the same identifier. This may enable a plurality of points of interest associated with the plurality of markers that include the same identifier to be easily accessed as a group within the deep map. In other instances, a plurality of markers may be correlated without sharing a common identifier. For example, the plurality of markers may include identifiers that only share a common portion (e.g. a common identifier prefix), the plurality of markers may include identifiers that are consecutive, the plurality of markers may be correlated within the deep map in a manner not related to the identifiers, or otherwise correlated without sharing a common identifier. The plurality of points of interest may be correlated to designate a common user, to designate a designed tour of a geographic area, according to a game, to designate an association with a particular entity or set of entities, by geographic area, according to a particular area of interest, or otherwise correlated. As is discussed further below, these correlation may be manipulated by the user(s) and/or the host of the deep map.

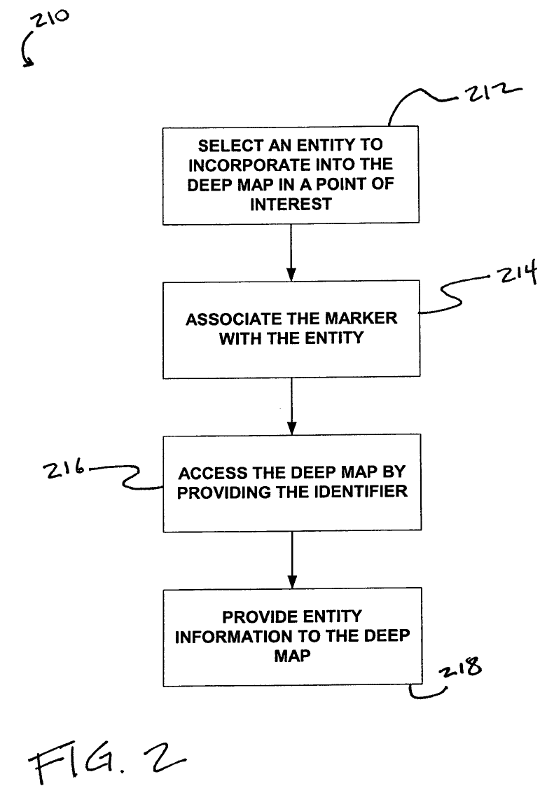

In some embodiments, operation 114 may enable a user that may not be affiliated with the host to use a marker to incorporate an entity into the deep map as a point of interest. FIG. 2 illustrates an exemplary embodiment of a method 210 of enabling a user to incorporate an entity as a point of interest into the deep map. Method 210 may include an operation 212, wherein the user selects an entity for incorporation into the deep map, an operation 214, wherein the user associates the marker with the entity, an operation 216, wherein the user accesses the deep map by providing the identifier included in the marker, and an operation 218, wherein the user provides point of interest information to the deep map.

According to some embodiments of the invention, the user may associate the marker with the entity at operation 214 by placing the marker such that other users that see the associated marker will affiliate the entity with the marker and vice versa. For example, the marker may be affixed to the entity, may be placed to draw attention to the entity, or otherwise associated with the entity. In some instances, the marker may include a sticker that may enable the marker to be placed in a desired location. In other instances, the marker may include a shirt, a pair of shoes, a hat, a bracelet, a necklace, or other piece of clothing or jewelry that may be worn by a person to include the wearer as a point of interest in the deep map. Markers may include objects that are fixed with respect to location (or substantially so), objects that may be portable or objects may be affixed to portable entities, and/or objects that are mobile under their own power. Other embodiments of markers exist.

For instance, a marker may include an RFID tag, or other short-range (or mid or long range) wireless transmitter. In this instance, the marker may wirelessly transmit a signal to other users enter into the transmission range of the marker to alert the users of its presence. This would enable the user's to detect the marker without visually seeing the physical marker. It should be appreciated that in this instance the marker may be placed out of plain view, and the association between the marker and the entity may be based on the placement of the marker with respect to the entity, and/or the location of the transmission range of the marker with respect to the entity (e.g., the entity is located within the transmission range, etc.).

According to various embodiments of the invention, the user may access the deep map at operation 216 by providing the identifier included in the marker. The identifier may be provided to the host. In some instances, the user may provide the identifier via electronic communication. For example, the user may provide the identifier over a network connection, such as a LAN connection (e.g. via a web client over an internet connection) or other network connection, a wireless connection (e.g. via text messaging using a wireless network protocol), or other electronic communication. In some instances, the user may provide the identifier via a short messaging service (SMS), a multimedia message service (MMS), an IP multimedia subsystem (IMS), an internet connection, and/or wireless application protocol (WAP). Providing the identifier may require that the identifier be manually entered by the user, or the marker may automatically provide the identifier to the user for communication to the host.

In some embodiments of the invention, after accessing the deep map by providing the identifier at operation 216, the user may provide point of interest information to the deep map at an operation 218. The point of interest information may be provided to the host. The point of interest information may be provided via the electronic communication that enabled the user to provide the identifier. Point of interest information may be composed of information selected entirely by the user, required information related to the entity, required information related to the user, or a combination of some or all of the above mentioned types of information. For example, the point of interest information may include the geographic location of the entity, and other information related to the entity that the user would like others to be able to access. For instance, point of interest information may include information associated with the entity typically included in deep maps; artistic material inspired by, reminiscent of, or otherwise related to the entity; a user's opinion about the entity; a command, cue, or request for a future user accessing the point of interest to perform an action; a question; a challenge; a way of interpreting an aspect of the entity; or other information. Some or all of the information may be entered automatically, such as, for example, GPS coordinates from which the user is accessing the deep map via a wireless connection, or other information. Point of interest information may include various types of media, such as, video, audio, still images, text, and/or other types of media. The identifier and the point of interest information may enable generation of a point of interest in the deep map.

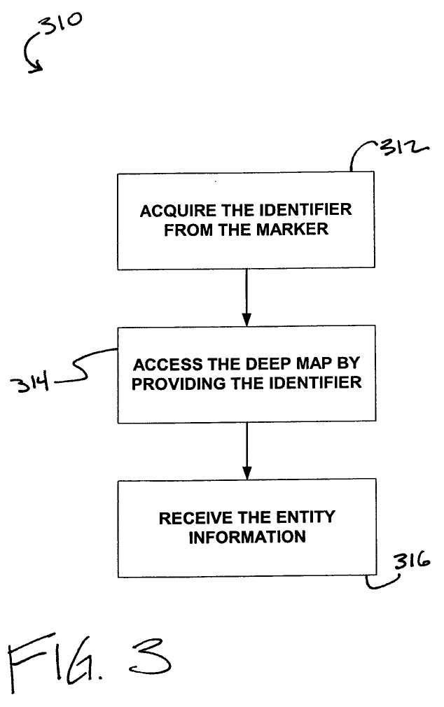

Referring back to FIG. 1, at operation 116 a user may access a point of interest in the deep map that has previously incorporated into the deep map by another user. The user may access the point of interest from the site of an entity that corresponds to the point of interest, or on location. FIG. 3 illustrates an exemplary embodiment of a method 310 of enabling a user to access a previously incorporated point of interest. According to method 310, the user may access the point of interest by acquiring an identifier from a marker that has been associated with an entity at an operation 312, accessing the deep map by providing the identifier included in the marker at an operation 314, and receiving point of interest information related to the entity from the deep map at an operation 316.

At operation 314, the user may access the deep map by providing the identifier included in the marker. The user may provide the identifier to the host. In some instances, the user may provide the identifier via electronic communication. For example, the user may provide the identifier over a network connection, such as a LAN connection (e.g. via a web client over an internet connection) or other network connection, a wireless connection (e.g. via text messaging using a wireless network protocol), or other electronic communication. In some instances, the user may provide the identifier via a short messaging service (SMS), a multimedia message service (MMS), an IP multimedia subsystem (IMS), an internet connection, and/or wireless application protocol (WAP). Providing the identifier may require that the identifier be manually entered by the user, or the marker may automatically provide the identifier to the user for communication to the host. In one embodiment in which the marker automatically provides the identifier to the user, the marker may transmit the identifier to a client device associated with the user. The client device may then either automatically provide the identifier to the host without subsequent interaction by the user, or the client device may “present” the marker to the user to enable the user to manually select the marker and initiate automatic provision of the identifier to the host.

At operation 316, the user may receive point of interest information related to the entity associated with the identifier provided by the user. The point of interest information may be provided by the host. In some instances, the user may receive the point of interest information via the same electronic communication medium that enabled the user to provide the identifier. For example, the user may receive the point of interest information over a network connection, such as a LAN connection (e.g. via a web client over an internet connection) or other network connection, a wireless connection (e.g. via text messaging using a wireless network protocol), or other electronic communication. The user may receive the point of interest information via the connection that the user provided the identifier to the deep map, or via another connection. In some instances, the user may receive the point of interest information via a short messaging service (SMS), a multimedia message service (MMS), an internet message service (IMS), an internet connection, and/or wireless application protocol (WAP).

In some embodiments of the invention, the user, after receiving the point of interest information, may provide comment information related to the point of interest in the deep map. The user may provide the comment information to the host. The comment information may be incorporated into the deep map as information associated with the point of interest. Comment information may include various types of media, such as, audio, video, still images, text, or other types of media. Comment information may be provided with point of interest information to users that access the point of interest in the future. In some embodiments, the host may associate host comment information with the point of interest. Host comment information may include advertising information, sponsor information, information related to the popularity of the point of interest, information related to the subjective merit of the point of interest, or other host comment information.

According to various embodiments, point of interest information, comment information, and/or host comment information may be edited. For example, a user that incorporates an entity into the deep map as a point of interest may subsequently edit originally provided point of interest information. The user may edit comment information included in the point of interest by other users. Similarly, the host may edit any or all of the point of interest information, the comment information, and the host comment information. In some embodiments, point of interest information and/or comment information may not be included in the deep map unless the information has been reviewed and approved by the host. Comment information may be excluded from inclusion into the deep map subject to approval by the user that originally incorporated the entity into the deep map as the point of interest.

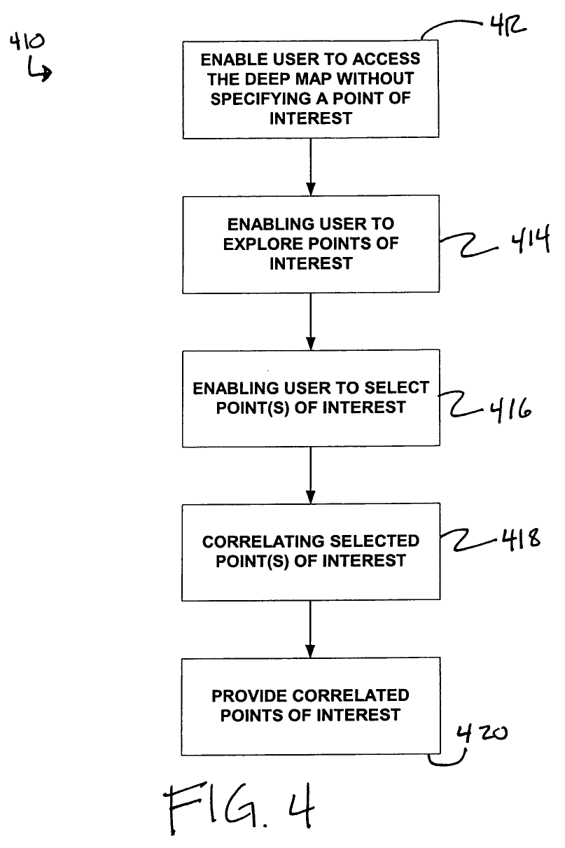

FIG. 4 illustrates an exemplary embodiment of a method 410 for enabling a user and/or the host to access the deep map to select points of interest to be correlated. For example, correlating points of interest may include grouping points of interest, ordering points of interest, linking points of interest, associating points of interest with other points of interest, organizing points of interest, or otherwise correlating points of interest. Method 410 may include an operation 412 that enables a user and/or the host to access a deep map without specifying a particular point of interest, an operation 414 that enables the user and/or the host to explore points of interest included in the deep map, an operation 416 that enables the user and/or the host to select one or more of the points of interest, an operation 418 that enables the user and/or the host to correlated selected points of interest selected points of interest, and an operation 420 that provides correlated points of interest as a group of points of interest.

In some embodiments of the invention, a user that may not be affiliated with the host may access the deep map as a whole at operation 412. In such instances, the deep map may be provided to the user by the host, at operation 412, according to a deep map organization option. For example, the deep map may be provided to the user in a cartographic form, wherein the user may select geographic locations within the deep map to access points of interest, the deep map may be provided to the user in a gallery form, wherein point of interest information is provided to the user as a gallery of points of interest, or the deep map may be provided to the user according to other deep map organization options.

According to various embodiments of the invention, a user that may not be affiliated with the host and/or the host may explore points of interest included in the deep map at operation 414. For example, at operation 414 the user may explore, or browse, points of interest that have been previously correlated (e.g., correlated by identifier, as discussed above, or otherwise correlated). In other instances, the user and/or the host may explore points of interest that may or may not have been correlated using known search techniques such as, for example, word searches, popularity, or other search techniques.

In some embodiments, a user that may not be affiliated with the host and/or the host may select one or more points of interest included in the deep map at operation 416. Selected points of interest may be correlated in a manner that may be specified by the user and/or the host at operation 418. The user and/or the host may select points of interest for correlation at operation 418 to correlate points of interest that may then be provided to the user, or other users, together at operation 420. This may provide one or more advantages to the user and/or the host such as, for example, pre-planning a tour of a geographic area (e.g. a city), creating and/or playing a game, correlating favorite points of interest, providing correlated points of interest to other users, or other advantages.

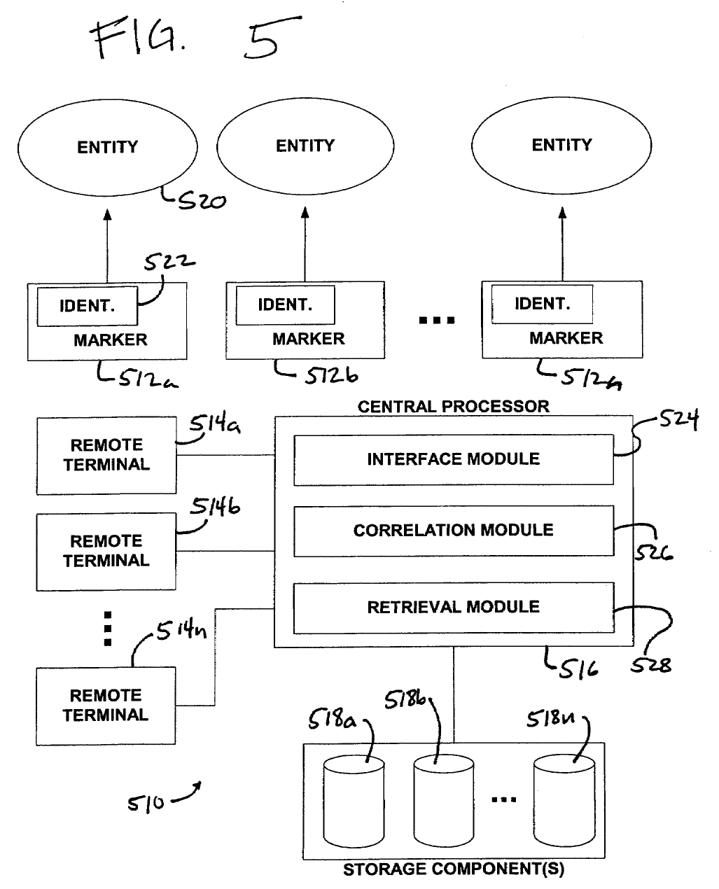

FIG. 5 illustrates an exemplary embodiment of a system 510 for generating and providing access to a deep map. System 510 may include one or more markers 512 (illustrated as marker 512a, marker 512b, and marker 512n), one or more remote terminals 514 (illustrated as remote terminal 514a, remote terminal 514b, and remote terminal 514n), a central processor 516 (illustrated as 516a, 516b, and 516n), and one or more storage components 518 (illustrated as storage component 518a, storage component 518b, and storage component 518n). System 510 may enable a host to administer the deep map such that the deep map may be generated interactively by one or more users that may not be affiliated with the host. System 510 may enable a user may incorporate an entity 520 into the deep map as a point of interest by associating marker 512a with entity 520, inputting an identifier 522 included in marker 512a to central processor 516 via remote terminal 514a, and inputting point of interest information to central processor 516 via remote terminal 514a. Central processor 516 may correlate identifier 522 with the point of interest information and transmit the correlated information to storage components 518. Central processor 516 and/or storage components 518 may be managed, controlled, maintained, or otherwise administered by the host. A user may access the point of interest within the deep map by acquiring identifier 522 from marker 512a associated with entity 520, and inputting identifier 522 to central processor 516 via remote terminal 514b. Central processor 516 may then retrieve point of interest information that corresponds to identifier 522 from storage components 518, and transmit the point of interest information to the user, who may receive the point of interest information via remote terminal 514b.

In some embodiments of the invention, remote terminals 514 may include a variety of terminal apparatus such as, for example, a PDA, a wireless telephone, a lap-top computer, a desktop computer, a handheld computer, a wireless pager device, or other terminal apparatus.

Although central processor 516 is illustrated as a single entity, this embodiment is illustrative only. Central processor 516 may include a plurality of processing units located in a single location, or remotely from each other.

It will be appreciated that although remote terminals 514 are illustrated as being directly linked to central processor 516, that this is for illustrative purposes only and meant merely to illustrate an operative communication link that terminates at one end at a respective remote terminal 514, and at the other end at central processor 516. This link may include, for example, a wired link, a wireless link, a dedicated link, a link via a network, a combination of some or all of these, or other links.

Storage components 518 are illustrated as being grouped locally to each other. However, this illustrated embodiment is not intended to be limiting. Storage components 518 may include any known data storage components, modules, and/or systems, including storage systems where components may be located remotely from each other such as, for example, in a distributed database, or other storage system.

In some embodiments of the invention, central processor 516 may include one or more modules. The modules may be implemented in hardware, software, firmware, or in a combination of some or all of hardware, software, and firmware. In some instances, the modules may include an interface module 524, a correlation module 526, and a retrieval module 528.

According to various embodiments of the invention, interface module 524 may provide an interface between a user and central processor 516. The interface provided may include a host interface that may be located at central processor 516 or remote from central processor 516, an interface that may enable a user to access central processor 516 as a client via one of remote terminals 514, or other interfaces. Interface module 524 may enable the user and/or the host to access the central processor via a graphical user interface (GUI). Accessing the central processor may enable the host to administer the deep map. Accessing central processor 516 may enable the user to provide an identifier to incorporate a point of interest into the deep map, enable the user to provide an identifier to receive point of interest information, enable the user to provide point of interest information to the deep map, enable the user to receive point of interest information, enable the user to otherwise access the deep map to view, manipulate, edit, select, organize, or access information associated with the deep map, or enable other functionalities.

In some embodiments, correlation module 526 may correlate point of interest information with one or more identifiers. Correlation module 526 may correlate point of interest information that is input by a user with-an identifier that is input by the user so that the point of interest information may be retrieved by providing the identifier. In some instances, correlation module 526 may correlate a plurality of points of interest. For example, correlating a plurality of points of interest may include organizing a plurality of points of interest according to identifiers and/or point of interest information. For instance, a plurality of points of interest may be correlated to designate a common user, to designate a designed tour of a geographic area, according to a game, to designate an association with a particular entity or set of entities, by geographic area, according to a particular area of interest, or otherwise correlated. A plurality of points of interest may be correlated based on user interaction, based on host interaction, or according to automated instructions.

According to various embodiments of the invention, a plurality of points of interest may be correlated to provide a designed tour of a geographic area. In such instances, the points of interest may be grouped and ordered so that a user taking the tour may proceed along the designated route. Point of interest information included in the points of interest correlated to provide a tour may include directions to and from the various points of interest to guide the user. Points of interest may be correlated to provide a tour by one or more users, or by the host.

In some embodiments, a plurality of points of interest may be correlated according to a game. In such instances, point of interest information included in the points of interest correlated according to a game may include commands, cues, or requests for users to perform prescribed actions. The prescribed actions may include, as non-limiting examples, searching for designated entities, interacting with certain entities (e.g. saying certain words to a designated individual), traveling to another point of interest included in the deep map, or other actions. Points of interest may be correlated according to a game by one or more users, or by the host. Other embodiments of correlating points of interest exist.

According to various embodiments of the invention, retrieval module 528 may retrieve point of interest information from storage components 518. Retrieval module 528 may retrieve point of interest information from storage components 518 based on an identifier that is provided to central processor 516 by a user as a request for point of interest information to be transmitted to the user, based on other user interaction, based on host interaction, or based on automated instructions.

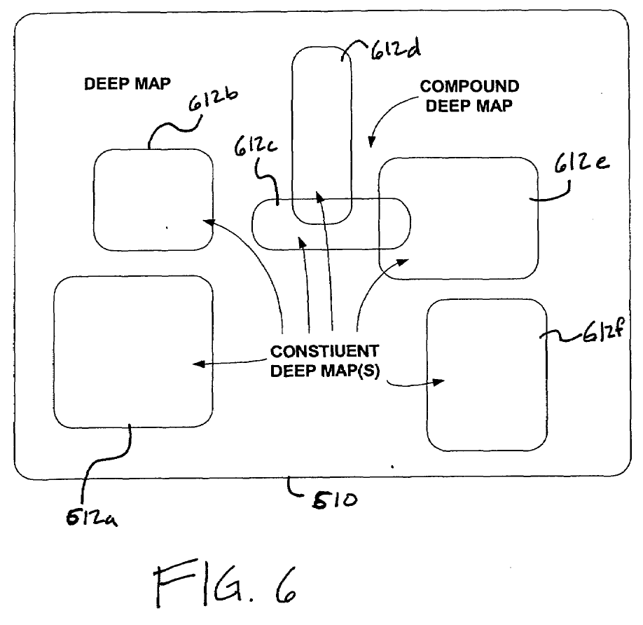

FIG. 6 illustrates an exemplary embodiment of the invention that may be related to organizing a plurality of correlated points of interest within a deep map 610 as one or more constituent deep maps 612 (illustrated as constituent map 612a, constituent map 612b, constituent map 612c, constituent map 612d, constituent map 612e, and constituent map 612f). For example, constituent deep maps 612 may include a plurality of points of interest that may be correlated to designate a common user, to designate a designed tour of a geographic area, according to a game, to designate an association with a particular entity or set of entities, by geographic area, according to a particular area of interest, or otherwise correlated. Organizing a plurality of correlated points of interest as one of constituent deep maps 612, may enable users accessing points of interest in one of constituent deep maps 612 to explore and access other related points of interest within the one of constituent deep maps 612.

In some embodiments of the invention, a plurality of constituent deep maps, such as constituent map 612c, 612d, and 612e, that overlap with one another may form a compound deep map 614. Organizing points of interest into constituent deep maps 512 and compound deep maps 514 may enable users accessing points of interest in one of constituent deep maps 512 to explore and access other related constituent deep maps 512.

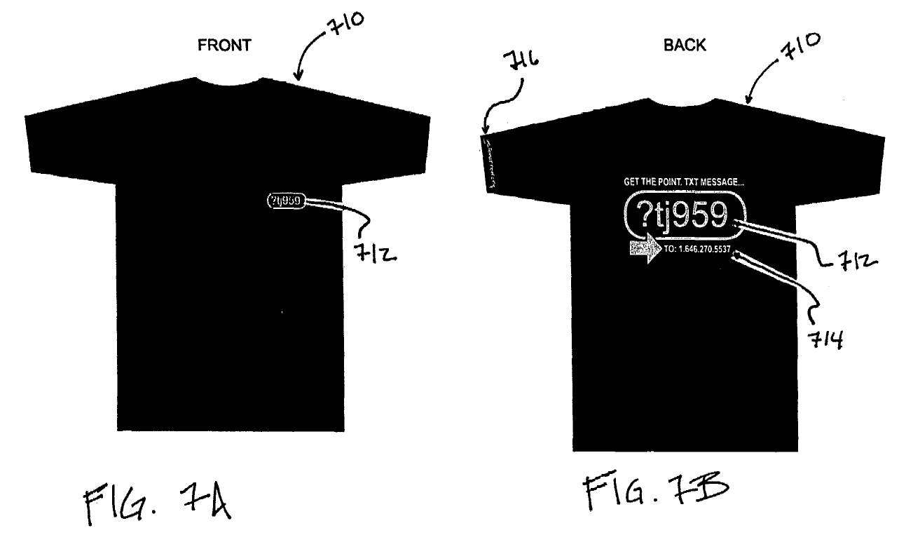

FIGS. 7A and 7B illustrate an exemplary embodiment of a marker 710 that may include a shirt. In other embodiments, marker 710 may include other items of clothing or jewelry that may be worn by a user. Marker 710 may include an alphanumeric identifier 712. In some instances, marker 710 may include one or more indicators related to methods of accessing the deep map. For example, marker 710 may include a number 714 at which the deep map may be accessed via wireless text messaging, a website 716 at which the deep map may be accessed via the Internet, or other indicators.

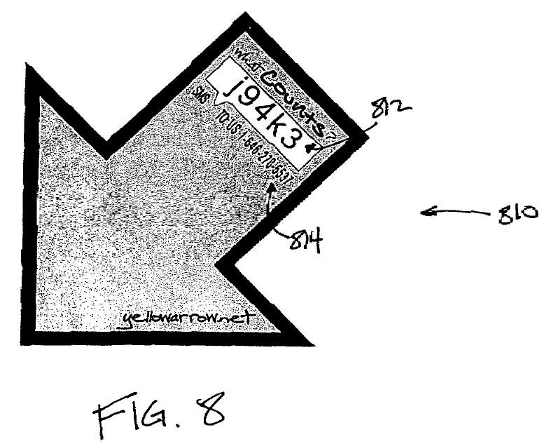

FIG. 8 illustrates an exemplary embodiment of a marker 810. Marker 810 may include an alphanumeric identifier 812. In some embodiments, marker 810 may include one or more indicators related to methods of accessing the deep map. For example, marker 810 may include a number 814 at which the deep map may be accessed via wireless text messaging, or other indicators. Marker 810 may be shaped to draw attention to an entity. As a non-limiting example, marker 810 may be shaped as an arrow. According to various embodiments, marker 810 may include a sticker. This may enable a user to associate marker 810 with an entity by affixing marker 810 to the entity, or affixing marker 810 to a surface in such a manner that the arrow points to the entity.

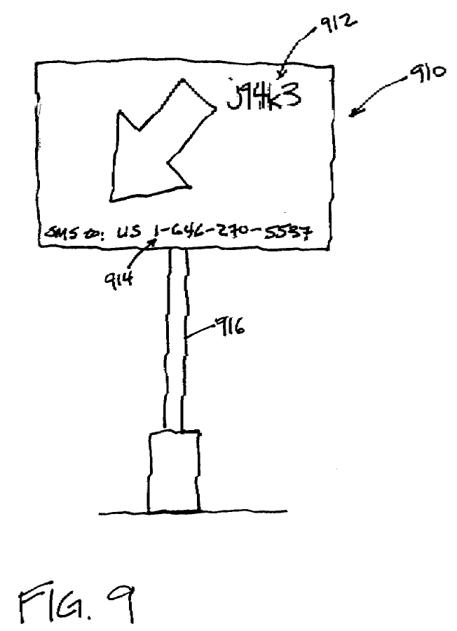

FIG. 9A is a elevation view of a marker 910 that may include a fixed sign. Marker 910 may include an alphanumeric identifier 912. In various embodiments, marker 910 may include one or more indicators related to methods of accessing the deep map, such as a number 914 at which the deep map may be accessed via wireless text messaging, or other indicators. Marker 910 may be held in place by a marker support 916. FIG. 9D illustrates one embodiment of marker 910 held in place by marker support 916. In other embodiments, illustrated in FIGS. 9B and 9C, marker 910 may be mounted, or otherwise affixed, to a surface, such as a wall, of a permanent structure.

Other embodiments of markers exist.

It can thus be appreciated that embodiments of the present invention have now been fully and effectively accomplished. The foregoing embodiments have been provided to illustrate the structural and functional principles of the present invention, and are not intended to be limiting. To the contrary, the present invention is intended to encompass all modifications, alterations and substitutions within the spirit and scope of the appended claims.

What is claimed is:

1. A method of generating a deep map, wherein the deep map is administered by a host and the deep map is generated, at least in part, by one or more users, the method comprising:
transferring a marker from the host to a user, wherein the marker includes an identifier;
the user associating the marker with an entity;
providing the identifier and point of interest information from the user to the host to enable the entity and associated point of interest information to be added to the deep map.

2. The method of claim 1, further comprising enabling an accessing user to access the point of interest in the deep map.

3. The method of claim 2, wherein the accessing user is enabled to access the point of interest in the deep map by providing the identifier to the host, and receiving the point of interest information from the host.

4. The method of claim 1, wherein the identifier includes at least one of an alphanumeric symbol, an optical code, an RFID signal, and a magnetic code.

5. The method of claim 1, wherein the marker is included in a set of markers.

6. The method of claim 5, wherein the identifiers included in markers included in the set of markers denote that the markers are included in the set of markers.

7. The method of claim 6, wherein the markers include a common identifier.

8. The method of claim 6, wherein the identifiers include a common portion.

9. The method of claim 5, wherein the set of markers are associated with at least one of a user, a group of users, a tour, a game, a particular entity, a particular set of entities, an area of interest, and a geographical area.

10. The method of claim 1, wherein the marker includes at least one of a sticker, a shirt, a pair of shoes, a hat, a bracelet, and a necklace.

11. The method of claim 1, wherein associating the marker with the entity includes physically placing the marker so as to visibly affiliate the marker with the entity.

12. The method of claim 11, wherein physically placing the marker includes affixing the marker to the entity.

13. The method of claim 11, wherein the physically placing the marker includes placing the marker so as to draw attention to the entity.

14. The method of claim 1, wherein the providing the point of interest information to the host is achieved by providing the point of interest information via an electronic media.

15. The method of claim 14, wherein the providing the identifier to the host is achieved by providing the identifier via an electronic media.

16. The method of claim 15, wherein electronic media is transmitted via at least one of a network connection, a non-network connection, wired connection and a wireless connection.

17. The method of claim 16, wherein electronic media is transmitted via at least one of wireless text messaging and a LAN network connection.

18. The method of claim 1, wherein the point of interest information includes at least one of information selected by a user, required information related to the entity, and required information related to a user.

19. The method of claim 1, wherein the point of interest information includes at least one of artistic material inspired by, or reminiscent of, the entity; the user's opinion about the entity; a command, cue, or request for a future user accessing the point of interest to perform an action; a question; a challenge; and a way of interpreting an aspect of the entity.

20. The method of claim 1, wherein the point of interest information includes at least one of video information, audio information, still image information, and text information.

21. The method of claim 1, wherein the point of interest information includes a geographic location of the entity.

22. The method of claim 1, wherein the point of interest information includes at least one of automatically provided information and information provided manually by a user.

23. The method of claim 3, wherein the providing the identifier is achieved by providing the identifier via an electronic media.

24. The method of claim 23, wherein the receiving the point of interest information includes receiving the point of interest information via an electronic media.

25. The method of claim 24, wherein electronic media is transmitted via at least one of a network connection, a non-network connection, wired connection and a wireless connection.

26. The method of claim 25, wherein electronic media is transmitted via at least one of wireless text messaging and a LAN network connection.

27. The method of claim 1, further comprising correlating the entity and associated point of interest information with at least one set of entities and associated point of interest information.

28. The method of claim 27, wherein the set of entities and associated point of interest information includes entities and associated point of interest information that are correlated according to at least one of a user, a group of users, a tour, a game a particular entity, a particular set of entities, an area of interest, a user selection, and a geographical area.

29. The method of claim 2, further comprising accessing other entities and associated point of interest information in the deep map.

30. The method of claim 29, wherein accessing other entities and associated point of interest information in the deep map includes accessing one or more entities and associated point of interest information that are included in a set of entities and point of interest information.

31. The method of claim 30, wherein the set of entities and associated point of interest information includes entities and associated point of interest information that are correlated according to at least one of a user, a group of users, a tour, a game, a particular entity, a particular set of entities, an area of interest, a user selection, and a geographical area.

32. The method of claim 1, further comprising providing entities and associated point of interest information within the deep map in cartographic form.

33. The method of claim 1, further comprising providing entities and associated point of interest information with the deep map in gallery form.

34. The method of claim 1, further comprising selecting the entity and associated point of interest information for inclusion in a set of entities and associated point of interest information.

35. The method of claim 1, further comprising associating host comment information with the entity and associated point of interest information.

36. The method of claim 35, wherein the host comment information includes at least one of advertising information, sponsor information, information related to a popularity of the point of interest, and information related to a subjective merit of the point of interest.

37. The method of claim 1, further comprising editing the point of interest information.

38. The method of claim 37, wherein the editing the point of interest information is performed by at least one of the user and the host.

39. The method of claim 2, further comprising the step of enabling the accessing user to provide comment information to the host for association with the entity and associated point of interest information.

40. The method of claim 39, further comprising the step of editing the comment information.

41. The method of claim 40, wherein the editing the comment information is performed by at least one of the user and the host.

42. A system for generating a deep map, wherein the deep map is administered by a host and the deep map is generated, at least in part, by one or more users that are not affiliated with the host, the system comprising:
a marker that includes an identifier and is transferred from the host to a user, the marker being capable of being associated with an entity by the user; and
a central processor associated with the host that receives the identifier from the user, receives point of interest information from the user, and creates a point of interest in the deep map by associating the point of interest information with the identifier.

43. The system of claim 42, further comprising at least one storage component associated with the host that stores the identifier and the point of interest information received by the central processor.

44. The system of claim 42, further comprising a remote terminal, wherein the user provides the identifier and the point of interest information to the central processor via the remote terminal.

45. The system of claim 42, wherein the central processor enables an accessing user to access the point of interest by receiving the identifier from the accessing user and providing the point of interest information to the accessing user in response to the reception of the identifier from the accessing user.

46. The system of claim 45, further comprising a remote terminal, wherein the accessing user provides the identifier to the central processor and receives the point of interest information from the central processor via the remote terminal.

47. The system of claim 45, further comprising:
a first remote terminal, wherein the user provides the identifier and the point of interest information to the central processor via the remote terminal; and
a second remote terminal, wherein the accessing user provides the identifier to the central processor and receives the point of interest information from the central processor via the remote terminal.

48. The system of claim 42, wherein the identifier includes at least one of an alphanumeric symbol, an optical code, an RFID signal, and a magnetic code.

49. The system of claim 42, wherein the marker includes at least one of a sticker, a shirt, a pair of shoes, a hat, a bracelet, and a necklace.

50. The system of claim 42, wherein the central processor receives the identifier via an electronic media.

51. The system of claim 47, wherein the electronic media is transmitted via at least one of wireless text messaging and a LAN network connection.

52. The system of claim 42, wherein the point of interest information includes at least one of artistic material inspired by, or reminiscent of, the entity; a user's opinion about the entity; a command, cue, or request for an accessing user that accesses the point of interest to perform an action; a question; a challenge; and a way of interpreting an aspect of the entity.

53. The system of claim 42, wherein the point of interest information includes at least one of video information, audio information, still image information, and text information.

54. The system of claim 42, wherein the marker is included in a set of markers.

55. The system of claim 54, wherein the identifiers included in markers included in the set of markers denote that the markers are included in the set of markers.

56. The system of claim 55, wherein the markers include a common identifier.

57. The system of claim 55, wherein the identifiers include a common portion.

58. The system of claim 54, wherein the set of markers are associated with at least one of a user, a group of users, a tour, a game, a particular entity, a particular set of entities, an area of interest, and a geographical area.

59. The system of claim 42, wherein the marker includes at least one of a sticker, a shirt, a pair of shoes, a hat, a bracelet, and a necklace.

60. The system of claim 42, wherein associating the marker with the entity includes physically placing the marker so as to visibly affiliate the marker with the entity.

61. The system of claim 60, wherein physically placing the marker includes affixing the marker to the entity.

62. The system of claim 61, wherein the physically placing the marker includes placing the marker so as to draw attention to the entity.

63. The method of claim 1, wherein the marker includes an object that could be mobile.

64. The system of claim 42, wherein the marker includes an object that could be mobile.
